(19) United States
(12) Patent Application Publication
(10) Pub. No.: US 2016/0314898 A1
(43) Pub. Date: Oct. 27, 2016

(54) HIGH VOLTAGE TRANSFORMER COMPRISING A COIL BOBBIN FOR CARRYING A HIGH VOLTAGE WINDING

(71) Applicant: KONINKLIJKE PHILIPS N.V., Eindhoven (NL)

(72) Inventors: BERND ACKERMANN, EINDHOVEN (NL); WOLFGANG EFFTINGE, HAMBURG (DE); ALBERT GARCIA-TORMO, EINDHOVEN (NL); CHRISTIAN HATTRUP, EINDHOVEN (NL); RALF KRÖGER, HAMBURG (DE); THOMAS SCHEEL, EINDHOVEN (NL); PETER LÜRKENS, EINDHOVEN (NL); ANTONIUS JOHANNES JOSEPH WISMANS, EINDHOVEN (NL)

(21) Appl. No.: 15/105,603

(22) PCT Filed: Dec. 11, 2014
(86) PCT No.: PCT/EP2014/077373

§ 371 Date: Jun. 17, 2016

(30) Foreign Application Priority Data
Dec. 19, 2013 (EP) 13198581.4

(51) Int. Cl. H01F 27/32; H05G 1/10; H01F 27/28

(52) U.S. Cl. CPC H01F 27/323; H01F 27/2823; H05G 1/10

(57) ABSTRACT

The invention relates to a high voltage transformer (50) comprising: a magnetic core (5); a low voltage winding (10); a high voltage winding (20); at least one inner sleeve (30); and a coil bobbin (24) for carrying the high voltage winding (20), wherein the coil bobbin (24) is configured to be arranged inside the at least one inner sleeve (30) and configured to be attached to the at least one inner sleeve (30) at an outer perimeter of the at least one inner sleeve (30); and wherein the coil bobbin (24) comprises at least one field-control electrode (22), which is adapted to shape an electric field generated by the high voltage winding (20).

### FIELD OF THE INVENTION

The invention relates to a coil bobbin for carrying a high voltage winding and a high voltage transformer comprising a corresponding coil bobbin.

### BACKGROUND OF THE INVENTION

The spectral composition of the X-rays coming from an X-ray tube depends on the acceleration voltage of the electron beam. As the different sorts of tissue in a living body have different absorption properties depending on the energy of the X-rays, this effect can be used to differentiate between different tissue compositions and thus allow more specific diagnosis of various pathological situations. Ideally, in computed tomography every other frame can be taken with a different energy level and the type of tissue can be examined in addition to the standard 3D-picture.

WO 2012 080 899 A1 describes a power supply unit for an X-ray radiation source comprising a high voltage generator for providing a basic current for the operation of an X-ray tube, a waveform generator and a pulse transformer for providing superimposable voltage peaks and a control unit for generating a counterbalance at an input of the pulse transformer to prevent saturation effects. Providing different reference waveform patterns leads to the prevention of overshooting and ringing.

In the described solution, the acceleration voltage of the electron beam is the superposition of the DC voltage created by the main high voltage generator and a high voltage pulse pattern created by a control unit and waveform generator in conjunction with the pulse transformer. The waveform generator creates a pulse pattern at low voltages and high currents. The pulse transformer converts this to a pulse pattern at high voltages and low currents and superposes it with the high DC voltage of the main generator. DE 42 04 092 A1 describes spool bodies used with coil chambers for coiled products e.g. high voltage transformers. A therein described spool body with at least one coil chamber is used for coiled products especially for high voltage transformers. The therein described passage between the chamber inner wall and the bottom of the chamber is adapted to the geometry of the coil.

The pulse transformer has to isolate the large voltage difference between the primary winding linked to the low voltage circuit of the waveform generator and the secondary winding linked to the high voltage circuit of the main generator. The operating frequency of the pulse transformer is determined by the duration of the pulse pattern defined by the application requirements outlined above. Therefore, it is not possible to reduce the size of the pulse transformer by increasing its operating frequency as can be done e.g. for the high voltage transformer in the main generator. Therefore, the high voltage isolation of the pulse transformer has to be designed with special care to avoid any unnecessary increase of its dimensions.

### SUMMARY OF THE INVENTION

There may be a need to improve the setup of a high voltage generator. These needs are met by the subject-matter of the independent claims. Further exemplary embodiments are evident from the dependent claims and the following description.

An aspect of the invention relates to a high voltage transformer comprising: a magnetic core; a low voltage winding; a high voltage winding; at least one inner sleeve; and a coil bobbin for carrying the high voltage winding, wherein the coil bobbin is configured to be arranged inside the at least one inner sleeve and configured to be attached to the at least one inner sleeve at an outer perimeter of the at least one inner sleeve; and wherein the coil bobbin comprises at least one field-control electrode, which is adapted to shape an electric field generated by the high voltage winding.

A further aspect of the invention relates to a coil bobbin for carrying a high voltage winding, the coil bobbin is configured to be arranged inside at least one inner sleeve and configured to be attached to the at least one inner sleeve at an outer perimeter of the at least one inner sleeve.

A further aspect of the invention relates to an X-ray system, comprising an X-ray tube and a high voltage transformer to supply the X-ray tube.

A further aspect of the invention relates to a high voltage test system comprising a high voltage transformer.

The bobbin carrying the high voltage winding is placed inside at least one closed sleeve. The bobbin is attached to the sleeve at its outer perimeter. If there is more than one sleeve, then neighboring sleeves are attached to each other at the outer perimeter of the smaller sleeve that is placed inside the larger sleeve.

The present invention allows minimizing the transformer volume by removing all plastic holders and spacers between the primary and the secondary windings, as well as using a labyrinth-like structure in the joints connecting upper and lower halves of the sleeves to maximize the surface distance.

Furthermore, field-control electrodes shape the electric field so that the peak amplitude is lower, thereby allowing reducing the thickness of the plastic parts.

According to an exemplary embodiment of the invention, the high voltage transformer comprises further at least two labyrinth seals, which are placed opposite to each other.

According to an exemplary embodiment of the invention, the high voltage transformer further comprises at least two insulating spring washers for retaining the sleeves carrying the high voltage winding.

According to an exemplary embodiment of the invention, the high voltage transformer further comprises a flange connected to an outer perimeter of the at least one inner sleeve for retaining the secondary coil bobbin carrying the high voltage winding.

According to an exemplary embodiment of the invention, the high voltage transformer further comprises a secondary coil bobbin, wherein the at least one field-control electrode is arranged on the faces of the secondary coil bobbin.

According to an exemplary embodiment of the invention, the high voltage transformer further comprises core edges, wherein the at least one field-control electrode is arranged on the core edges.

According to an exemplary embodiment of the invention, the high voltage transformer further comprises at least one insulating high voltage wire pipe.

According to an exemplary embodiment of the invention, the coil bobbin comprises further at least one field-control electrode, which is adapted to shape an electric field generated by the high voltage winding.

According to an exemplary embodiment of the invention, the coil bobbin is adapted for use in a high voltage transformer.

### BRIEF DESCRIPTION OF THE DRAWINGS

A more complete appreciation of the invention and the attendant advantages thereof will be more clearly understood by reference to the following schematic drawings, which are not to scale, wherein:

FIG. 1 shows a schematic perspective three-dimensional projection of a high voltage transformer according to an exemplary embodiment of the invention;

FIG. 2 shows a schematic perspective three-dimensional projection of a high voltage transformer according to a further exemplary embodiment of the invention;

FIG. 3 shows a schematic cross section parallel to the core of a high voltage transformer according to an exemplary embodiment of the invention;

FIG. 4 shows a schematic cross section perpendicular to the core of a high voltage transformer according to an exemplary embodiment of the invention;

FIG. 5 shows an X-ray system or a high voltage system according to an exemplary embodiment of the invention; and

FIG. 6 shows a schematic perspective three-dimensional projection of a high voltage transformer according to a further exemplary embodiment of the invention.

### DETAILED DESCRIPTION OF EMBODIMENTS

The illustration in the drawings is schematically and not to scale. In different drawings, similar or identical elements are provided with the same reference numerals.

Generally, identical parts, units, entities or steps are provided with the same reference symbols in the figures.

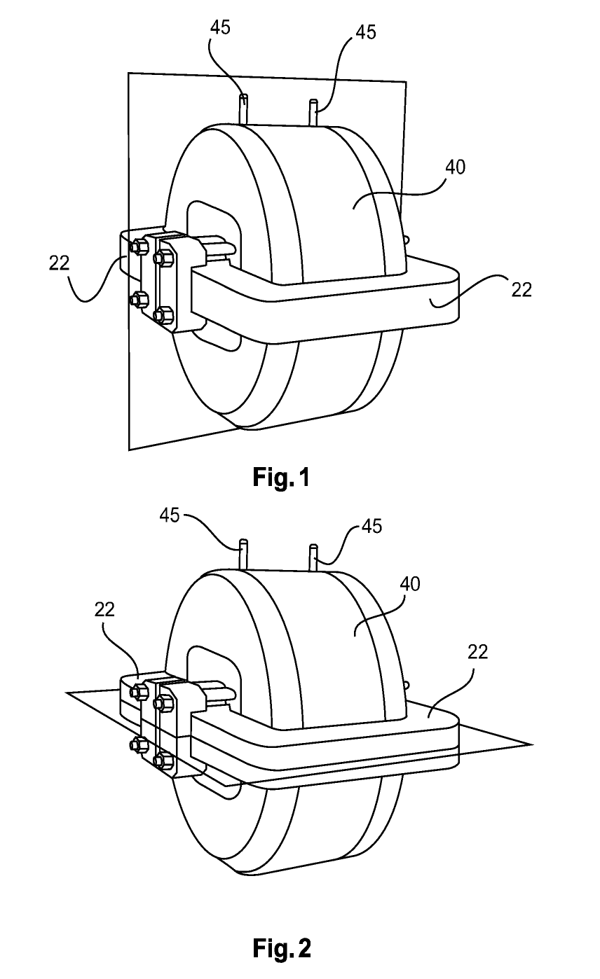

FIG. 1 shows a schematic perspective three-dimensional projection of a high voltage transformer according to an exemplary embodiment of the invention.

FIG. 1 shows a pulse transformer or high voltage transformer. FIG. 1 defines a perpendicular cross section of a high voltage transformer with respect to its core according to an exemplary embodiment of the invention, which is shown in FIG. 4. Aluminum shells acting as field-control electrodes 22 may cover the magnetic cores of the high voltage transformer. The outer sleeve 40 encloses the inner sleeve and the high voltage winding. The high voltage wire pipes 45 guide the connections of the high voltage winding away from the field control electrodes 22 covering the magnetic cores.

FIG. 2 shows a schematic perspective three-dimensional projection of a high voltage transformer according to a further exemplary embodiment of the invention.

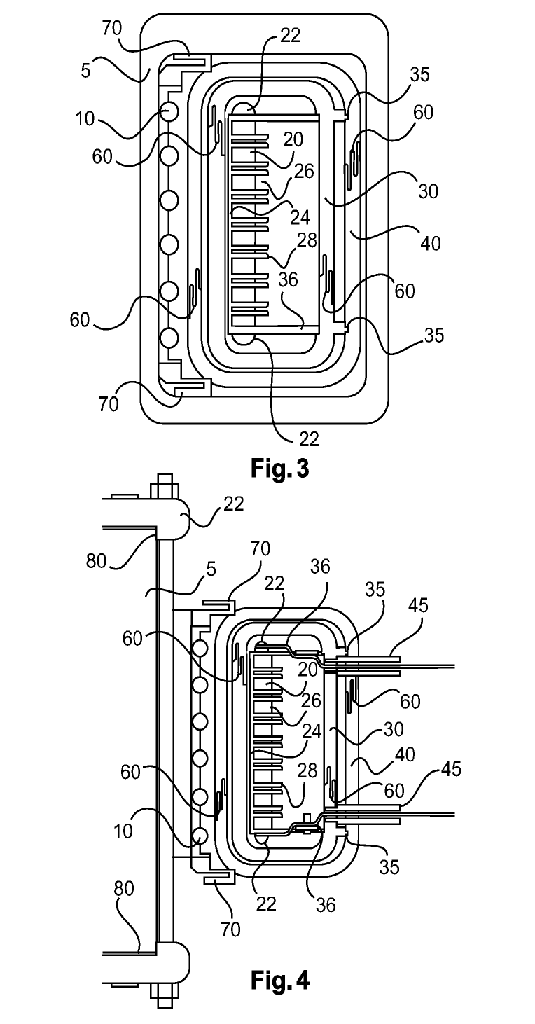

FIG. 2 shows a pulse transformer or high voltage transformer. FIG. 2 defines a parallel cross section of a high voltage transformer with respect to its core according to an exemplary embodiment of the invention, which is shown in FIG. 3. Aluminum shells acting as field-control electrodes 22 may cover the magnetic cores of the high voltage transformer. The outer sleeve 40 may enclose the inner sleeve and the high voltage winding. The high voltage wire pipes 45 guide the connections of the high voltage winding away from the field control electrodes 22 covering the magnetic cores.

FIG. 3 shows a schematic cross section parallel to the core of a high voltage transformer according to an exemplary embodiment of the invention.

FIG. 3 shows the attachment of the bobbin of the high voltage winding to the inner sleeve and of the inner sleeve to the outer sleeve, in a parallel two dimensional cross section. For simplification, only one half of the high voltage transformer is shown. The high voltage transformer may comprise: a magnetic core 5, a low voltage winding 10, a high voltage winding 20, at least one inner sleeve 30, and a coil bobbin 24 for carrying the high voltage winding 20.

Optionally, the magnetic core 5 is made of a soft magnetic material, e.g. ferromagnetic material and/or ferrimagnetic material. The magnetic core 5 may comprise iron or nickel or alloys of iron or nickel or ceramic oxides of metals.

The inner sleeve 30 may be fabricated from a plastic material or any other non-conductive synthetic or semi-synthetic solid material.

Optionally, the winding wire of the low voltage winding 10 and/or of the high voltage winding 20 is made of copper or a copper alloy or of aluminum or of an aluminum alloy, and the winding wire may coated with a very thin layer of insulation.

Optionally, in one embodiment of the invention, the coil bobbin 24 may be divided into multiple slots 26, so that the voltage difference within each slot becomes only a fraction of that between the terminals of the high voltage winding. Thin insulation slots 28 between winding slots avoid discharges going over the bobbin surface. These insulation slots may also be used to return the winding wire from the top of one slot to the bottom of the next slot.

The coil bobbin 24 may be configured to be arranged inside the at least one inner sleeve 30 and may be configured to be attached to the at least one inner sleeve 30 at an outer perimeter of the at least one inner sleeve 30.

The coil bobbin 24 may be fabricated from a plastic material or any other non-conductive synthetic or semi-synthetic solid material.

The coil bobbin 24 may comprise at least one field-control electrode 22, which is adapted to shape an electric field generated by the high voltage winding 20.

The magnetic core 5 may be a soft magnetic core.

The high voltage transformer may further comprise at least one outer sleeve 40.

The high voltage transformer may further comprise an attachment 35 of the at least one inner sleeve 30 to the at least one outer sleeve 40 and attachment or flange 36 of high voltage winding 20 to the at least one inner sleeve 30.

The high voltage transformer may further comprise at least one insulating high voltage wire pipe 45. The high voltage wire pipe 45 may be fabricated from a plastic material or any other non-conductive synthetic or semi-synthetic solid material. The high voltage transformer may further be fabricated by applying a press-fixture to the high voltage transformer assembly.

The high voltage transformer 50 may further comprise further at least two labyrinth seals 60, which are placed opposite to each other. The labyrinth seals 60 may be fabricated as structures in an upper half and in a lower half of the inner sleeve 30 or as structures in an upper half and in a lower half of the outer sleeve 40. The outer sleeve 40 may be fabricated from a plastic material or any other non-conductive synthetic or semi-synthetic solid material.

The high voltage transformer 50 may further comprise at least two insulating spring washers 70 for retaining the high voltage winding 20. The insulating spring washers 70 may be fabricated from a plastic material or any other non-conductive synthetic or semi-synthetic solid material.

FIG. 4 shows a schematic cross section perpendicular to the core of a high voltage transformer according to an exemplary embodiment of the invention.

FIG. 4 shows the attachment of the bobbin of the high voltage winding to the inner sleeve and of the inner sleeve to the outer sleeve in the perpendicular two dimensional cross section. For simplification, only one half of the high voltage transformer is shown.

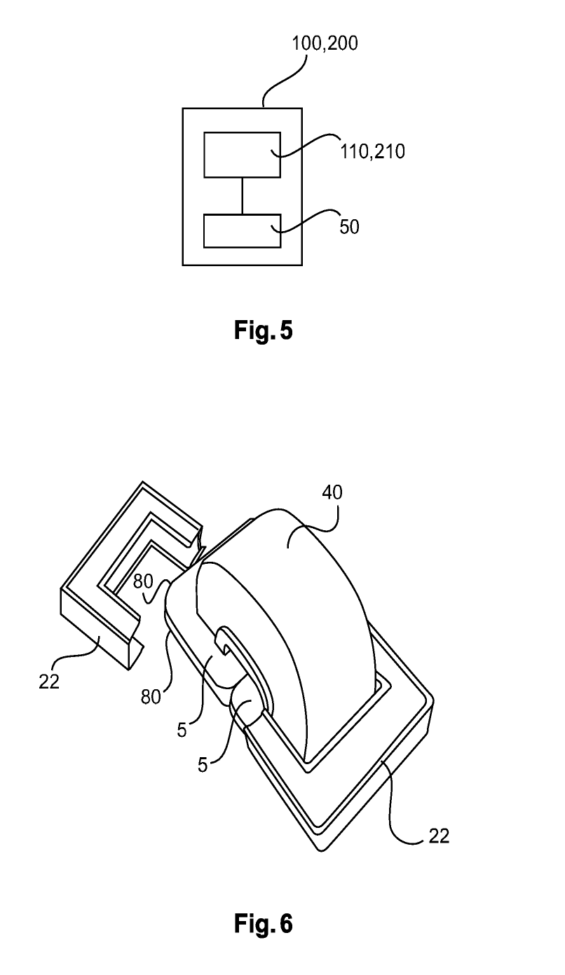

FIG. 5 shows an X-ray system according to an exemplary embodiment of the invention.

An X-ray system 100 may comprise an X-ray tube 110 and a high voltage transformer 50 which is configured to supply the X-ray tube 110.

A high voltage test system 200 may comprise a high voltage transformer 50 which is configured to supply high voltage consumer 210.

FIG. 6 shows a schematic perspective three-dimensional projection of a high voltage transformer according to a further exemplary embodiment of the invention.

The high voltage transformer as shown in FIG. 6 comprises field-control electrodes 22 on core edges 80, aluminum shells covering the magnetic core 5, wherein the field-control electrodes 22 are arranged on the core edges 80.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SIGNS:

5 magnetic core

10 a low voltage winding

20 a high voltage winding

22 field-control electrode

24 coil bobbin

26 slot

28 insulation slot

30 inner sleeve

35 attachment

36 attachment (flange)

40 outer sleeve

45 high voltage wire pipe

50 high voltage transformer

60 labyrinth seal

70 insulating spring washer

80 core edge

100 X-ray system

110 X-ray tube

200 high voltage test system

210 high voltage consumer

1. A high voltage transformer comprising:
a magnetic core;
a low voltage winding;
a high voltage winding;
an inner closed sleeve;
an outer sleeve enclosing the inner closed sleeve and the high voltage winding;
wherein
a coil bobbin for carrying the high voltage winding, wherein the coil bobbin is arranged inside the inner closed sleeve and attached to the inner closed sleeve at an outer perimeter of the inner closed sleeve; and
wherein the coil bobbin comprises at least one field-control electrode, which is adapted to shape an electric field generated by the high voltage winding.

2. The high voltage transformer according to claim 1, wherein the high voltage transformer comprises further at least two labyrinth seals, which are placed opposite to each other.

3. The high voltage transformer according to claim 1, wherein the high voltage transformer further comprises at least two insulating spring washers for retaining the high voltage winding.

4. The high voltage transformer according to claim 3, wherein the high voltage transformer further comprises a flange connected to an outer perimeter of the inner closed sleeve for retaining the high voltage winding.

5. The high voltage transformer according to claim 1, wherein the at least one field-control electrode is arranged on the faces of the coil bobbin.

6. The high voltage transformer according to claim 5, wherein the high voltage transformer further comprises core edges, wherein the at least one field-control electrode is arranged on the core edges.

7. The high voltage transformer according to claim 1, wherein the high voltage transformer further comprises at least one insulating high voltage wire pipe.

8. A coil bobbin for carrying a high voltage winding, wherein the coil bobbin
is arranged inside a closed sleeve and is attached to the closed sleeve at an outer perimeter of the closed sleeve.

9. The coil bobbin according to claim 8,
wherein the coil bobbin comprises further at least one field-control electrode, which is adapted to shape an electric field generated by the high voltage winding.

10. The coil bobbin according to claim 8, wherein the coil bobbin is adapted for use in a high voltage transformer.

11. An X-ray system, comprising an X-ray tube and a high voltage transformer according to claim 1 to supply the X-ray tube.

12. A high voltage test system comprising a high voltage transformer according to claim 1.
